(19) United States
(12) Patent Application Publication
(10) Pub. No.: US 2025/0019302 A1
(43) Pub. Date: Jan. 16, 2025

(54) CEMENT KILN ENERGY-SAVING ADMIXTURE WITH RARE EARTH AND ITS PREPARATION METHOD

(71) Applicants: BAOTOU HONGRUN RARE EARTH TECIINOLOGY CO., LTD., Baotou (CN); BEIJING HONGKERUIDA ENGINEERING CO.,LTD., Beijing (CN)

(72) Inventors: Jinzheng HE, Beijing (CN); Jun ZHANG, Beijing (CN); Lixin LU, Beijing (CN); Quansen ZHANG, Beijing (CN)

(73) Assignees: BAOTOU HONGRUN RARE EARTH TECIINOLOGY CO.,LTD., Baotou (CN); BEIJING HONGKERUIDA ENGINEERING CO.,LTD., Beijing (CN)

(21) Appl. No.: 18/902,175

(22) Filed: Sep. 30, 2024

Related U.S. Application Data
(63) Continuation of application No. PCT/CN2022/125351, filed on Oct. 14, 2022.

(30) Foreign Application Priority Data
Apr. 13, 2022 (CN) 2022103852474

(51) Int. Cl. C04B 7/42

(52) U.S. Cl. CPC C04B 7/424

(57) ABSTRACT

This invention discloses a rare earth energy-saving admixture and its preparation method for cement kilns, involving the field of energy saving and emission reduction technology for cement kilns. The invention, without changing or minimally changing existing hardware equipment, reduces the thermal consumption of the production system and sulfur-nitrogen and sulfur emissions by conducting a thermodynamic diagnosis and calculating the amount of rare earth energy-saving admixture to be added, thereby saving the cost of retrofitting large hardware equipment.

### CROSS-REFERENCE TO RELATED APPLICATIONS

The application claims priority to Chinese patent application No. 2022103852474, filed on Apr. 13, 2022, the entire contents of which are incorporated herein by reference.

### TECHNICAL FIELD

This invention pertains to the field of energy saving and emission reduction technology for cement kilns, particularly to a rare earth energy-saving admixture for cement kilns and its preparation method.

### BACKGROUND

Under the premise of ensuring no reduction in the quality of cement, in the face of the high consumption of raw materials and fuels, and the large emission of harmful gases in the production process of cement clinker, the development of more advanced and diversified energy-saving technologies is urgently needed for the sustainable development of the cement industry.

Currently, in the production process of cement clinker, where poor burnability, low clinker strength, high specific energy consumption, and strict control of NOx and SOx emission indicators are common, the widely adopted methods are, on the one hand, technical improvements to the preheater system by adding hardware equipment such as SNCR, SCR, staged combustion, low-nitrogen burners, and hot raw material desulfurization devices; on the other hand, readjusting the existing raw material component ratios in the factory to improve the sintering conditions of the clinker and reduce emissions.

However, the problems lie in: 1. The addition of external equipment still requires a large amount of consumables, and the cumulative costs remain high. 2. Adjusting the raw material mixture based on the existing materials in the factory is limited by the differences in the mineral conditions of the original mines, making it difficult to eliminate the impact of harmful substances on the sintering conditions.

Considering the large output and the need for long-term continuous operation of cement kilns, when the above reasons cause fluctuations in the quality of the produced clinker and the strength does not meet the standards, it will bring huge economic losses and a loss of reputation and trust to the enterprise.

### SUMMARY

To address the aforementioned technical issues, this invention provides a rare earth energy-saving admixture for cement kilns and its preparation method, which reduce the overall thermal consumption and the emission of nitrogen and sulfur.

To achieve this technical goal, the invention adopts the following scheme:

A rare earth energy-saving admixture for cement kilns, calculated by mass fraction, includes 4-22% rare earth composite oxides, 31-49% urea, and 30-49% gypsum.

Furthermore, the rare earth composite oxides consist of La2O3 and Y2O3, with La2O3 content ranging from 98-99%.

The preparation method for the rare earth energy-saving admixture for cement kilns is carried out in the following steps:
Step S1: Conduct a thermodynamic diagnostic survey on the original sintering process and material ratio.

Choose a period of stable process operation to conduct thermodynamic calibration of the preheater, high-temperature fan, rotary kiln, calciner, and cooler, and obtain the actual thermal consumption Q1 of the existing clinker based on the measured values.
Step S2: Based on the thermodynamic diagnostic survey, with the ideal clinker index thermal consumption Q0 as the target, calculate the required amount of rare earth energy-saving admixture to be added W in reverse according to the current situation analysis results:

$$\text{\textbackslash [} W / \% = ∖ frac \{ ( Q l - Q 0 ) \} \{ Q 2 \} \backslash times 1.5 + 0.05 ∖ ]$$

Where Q0 is the ideal clinker thermal consumption, Q1 is the actual thermal consumption of the existing clinker, and Q2 is the average reduction indicator of the rare earth energy-saving admixture.
Step S3: Measure the content of tricalcium silicate C3S (A mineral), dicalcium silicate C2S (B mineral) in the clinker with added rare earth energy-saving admixture, and the thermal energy consumption in real-time, and plot the measurement data into a curve to establish a data model.
Step S4: Within the range of W data obtained in S2, select different amounts of data and bring them into the model of S3, comparing and analyzing the comprehensive thermal consumption of each addition point.
Step S5: Use different amounts of rare earth energy-saving admixture selected in S4 to mix with the existing raw material to obtain mixed raw material, and after high-temperature firing at 1450° C. to obtain clinker, perform strength testing on the clinker.
Step S6: Determine the amount of rare earth energy-saving admixture to be added based on the basic selection condition of reducing the thermal consumption to below the ideal clinker thermal consumption, and the value of strength improvement as the preferred condition.

Furthermore, the average reduction indicator Q2 of the rare earth energy-saving admixture is (5% to 10%) of Q1.

Furthermore, in step S5, the rare earth energy-saving admixture is ground to a particle size of less than 0.5 mm before being mixed with the raw material.

Compared with existing technology, the beneficial effects of this invention are:
1. It can reduce the melting point temperature, increase the sintering speed, and reduce thermal consumption by 3-7%.
2. It improves the sintering conditions of cement, enhancing the strength of the clinker.
3. It solidifies sulfur and denitrifies, reducing the emission of harmful gases, playing a role in energy saving, emission reduction, and reducing production costs, thereby achieving the sustainable development goals of the cement industry.
4. Without changing or minimally changing existing hardware equipment, through the diagnosis of the production system, the soft process improvement of the rare earth energy-saving admixture preparation model is implemented, thereby maximizing the potential for process improvement and saving the cost of adding and retrofitting large hardware equipment.

### BRIEF DESCRIPTION OF DRAWINGS

FIG. 1 is a data model diagram provided for Example 1 of the present invention.

FIG. 2 is a data model diagram provided for Example 2 of the present invention.

### DETAILED DESCRIPTION OF THE EMBODIMENTS

To fully understand the purpose, characteristics, and efficacy of the present invention, the following detailed description of the implementation is provided, but the invention is not limited to this.

The invention provides a rare earth energy-saving admixture for cement kilns, which is composed of the following components by mass fraction: 4-22% rare earth composite oxides, 31-49% urea, and 30-49% gypsum. The rare earth composite oxides consist of La2O3 and Y2O3, with La2O3 content ranging from 98-99%.

The rare earth compounds in the rare earth energy-saving admixture act to enhance oxidation and catalyze the reaction rate of materials, increasing the rate of temperature rise, thereby causing the low-temperature liquid phase to occur earlier to form an intermediate transition phase. This transition phase decomposes into C3S at a lower temperature, thus reducing the formation temperature of A mineral. Urea begins to thermally decompose at temperatures above 150° C. to produce ammonia gas, which on one hand reacts with nitrogen oxides in the exhaust gas to form nitrogen gas and is discharged, and on the other hand reacts with sulfur compounds in the flue gas to form ammonium sulfite, which then reacts with calcium and alumina raw materials in the material to form calcium sulfoaluminate entering the kiln, thereby achieving the effects of denitrification and sulfur fixation. Gypsum, as an alkaline calcium material, reacts with acidic volatiles in the flue gas to produce a neutralizing sulfur fixation reaction, and after entering the kiln, it has a mineralizing effect on reducing the melting point, promoting chemical coordination in the liquid phase, and increasing the sintering speed.

### Implementation Example 1

The rare earth energy-saving admixture for cement kilns is composed of the following components by mass fraction: 15% rare earth composite oxides, 40% urea, and 45% gypsum. The rare earth composite oxides consist of La2O3 and Y2O3, with a La2O3 content of 98%.

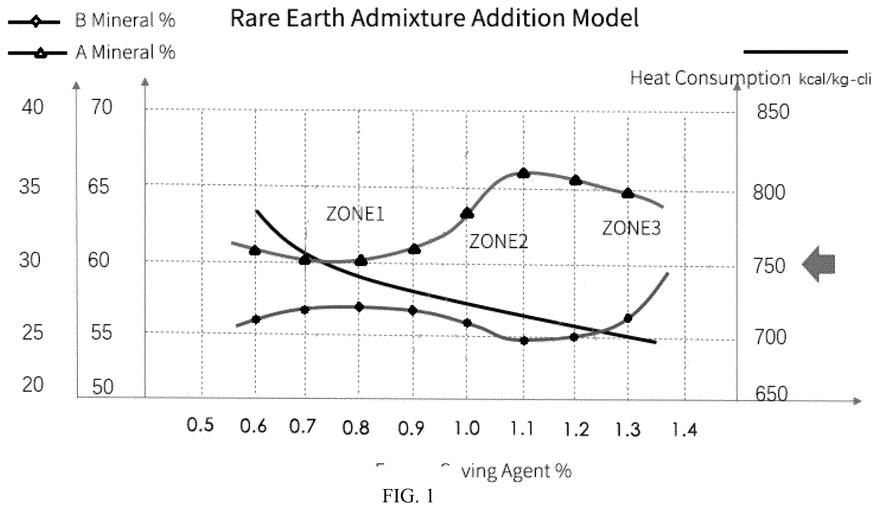

The method of the present invention was implemented at a cement company's plant A, with the specific steps as follows:
Step S1: Conduct an actual thermodynamic calibration of the original sintering conditions of the cement kiln, measuring the air volume, air pressure, and temperature data of the preheater, high-temperature fan, rotary kiln, calciner, and cooler. It is known from the measurements that producing one kilogram of clinker requires 0.126 kg of coal and 1 m³ of air. The thermal consumption of the clinker is the amount of coal consumed per unit mass of clinker produced, which in this example is 0.126 kg of coal/kg of clinker. With a calorific value of coal at 6200 kcal/kg, the actual thermal consumption Q1 of the existing clinker is calculated to be 780 kcal/kg-cli.
Step S2: Set the ideal clinker thermal consumption Q0 to 750 kcal/kg-cli, and the average reduction indicator Q2 of the rare earth energy-saving agent is 39-78 kcal-cli. Substitute the data into the formula W %=(Q1−Q0)/Q2×1.5+0.05, and calculate the range of W to be 0.6-1.2.
Step S3: Measure the content of A mineral and B mineral in the clinker with added rare earth energy-saving admixture, and the thermal energy consumption, and plot the measurement data into a curve to form a data image model, as shown in FIG. 1. According to the image model, the content changes of A mineral and B mineral are divided into three stages (i.e., three areas in the figure): In the first stage (content of rare earth energy-saving admixture 0.5-0.9%), the content of A mineral slowly decreases and then slowly rises, and the content of B mineral slowly increases and then slowly decreases; In the second stage (content of rare earth energy-saving admixture 0.9-1.2%), the content of A mineral significantly increases and then slightly decreases, and the content of B mineral significantly decreases and then slightly increases; In the third stage (content of rare earth energy-saving admixture 1.2-1.4%), the content of A mineral gradually decreases, and the content of B mineral significantly increases.
Step S4: Based on the range of the additive amount W obtained in S2, select several data points of additive amount, bring them into the data image model, and analyze the comprehensive thermal consumption under specific additive amounts.
Specifically, select five data points of 0.6%, 0.7%, 0.8%, 1.0%, and 1.2% for model comparison and analysis:
When the additive amount is 0.6%, the content of A mineral is 61%, the content of B mineral is 26%, and the comprehensive thermal consumption is 780 kcal-cli, the same as the original clinker thermal consumption.
When the additive amount is 0.7%, the content of A mineral is 60%, the content of B mineral is 27%, and the comprehensive thermal consumption is 760 kcal-cli, a reduction of 2.6% from the original thermal consumption of 780 kcal/kg-cli.
When the additive amount is 0.8%, the content of A mineral is 60.1%, the content of B mineral is 27.1%, and the comprehensive thermal consumption is 740 kcal-cli, a reduction of 5.1% from the original thermal consumption of 780 kcal/kg-cli.
When the additive amount is 1.0%, the content of A mineral is 63.8%, the content of B mineral is 26%, and the comprehensive thermal consumption is 725 kcal-cli, a reduction of 7.1% from the original thermal consumption of 780 kcal/kg-cli.
When the additive amount is 1.2%, the content of A mineral is 65.5%, the content of B mineral is 25%, and the comprehensive thermal consumption is 710 kcal-cli, a reduction of 9% from the original thermal consumption of 780 kcal/kg-cli.

Comparing the above five sets of data, when the additive amount is 0.6% and 0.7%, the thermal consumption does not decrease to the ideal clinker thermal consumption value, which is inconsistent with the purpose of reducing thermal consumption of this invention. The additive amounts of 0.8%, 1.0%, and 1.2% are the optional data range.
Step S5: Select the clinker with different amounts of rare earth energy-saving admixture from S4 for strength testing, and the results are shown in Table 1.

TABLE 1
Clinker Strength of Implementation Example 1

| Additive Amount/% | 0.8 | 1.0 | 1.2 | 0 |
|---|---|---|---|---|
| Strength/MPa | 54 | 53 | 52.3 | 52.5 |

**From the data in Table 1, it can be seen that under the condition of 0.8% addition of rare earth energy-saving admixture, the clinker strength is increased by 1.5 MPa.**
Step S6: The basic selection condition is to reduce the thermal consumption to below the ideal clinker thermal consumption, and the value of strength improvement is the preferred condition, determining the addition amount of the rare earth energy-saving admixture to be 0.8%. The clinker with the determined addition amount is tested for nitrogen oxide content and desulfurization effect.
Under the condition of 0.8% addition of the rare earth energy-saving admixture, the original thermal consumption is reduced by 5% on the basis of 780 kcal/kg, and it can stably reach an operation of 740 kcal/kg; the clinker strength is increased by 1.5 MPa; the nitrogen oxide content is reduced from the original 120 mg/m3 to below 70 mg/m3; the desulfurization effect can be reduced by about 30%.

### Implementation Example 2

The rare earth energy-saving admixture for cement kilns is composed of the following components by mass fraction: 15% rare earth composite oxides, 40% urea, and 45% gypsum. The rare earth composite oxides consist of La2O3 and Y2O3, with a La2O3 content of 98%.

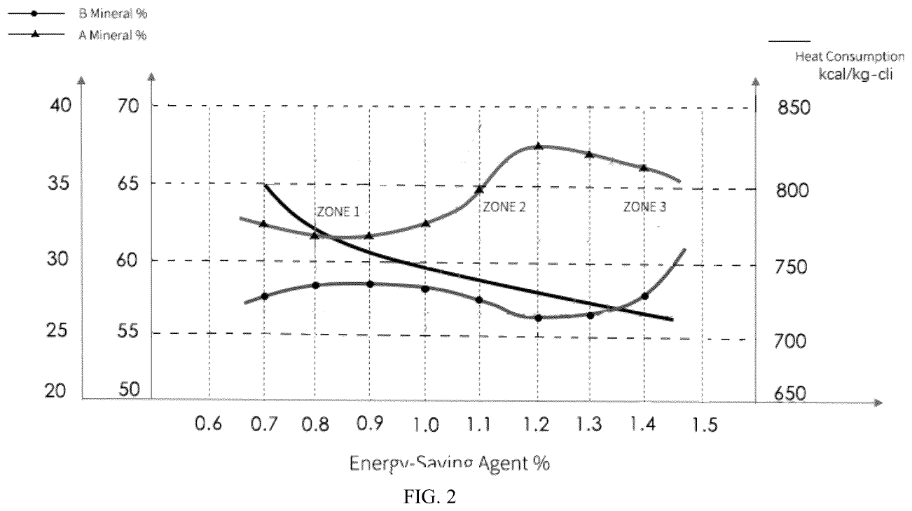

The method of the present invention is implemented at a cement company's plant B, with the specific steps as follows:
Step S1: Conduct an actual thermodynamic calibration of the original sintering conditions of the cement kiln, measuring the air volume, air pressure, and temperature data of the preheater, high-temperature fan, rotary kiln, calciner, and cooler. It is known from the measurements that producing one kilogram of clinker requires 0.129 kg of coal and 1 m³ of air. The thermal consumption of the clinker is the amount of coal consumed per unit mass of clinker produced, which in this example is 0.129 kg of coal/kg of clinker. With a calorific value of coal at 6200 kcal/kg, the actual thermal consumption Q1 of the existing clinker is calculated to be 800 kcal/kg-cli.
Step S2: Set the ideal clinker thermal consumption Q0 to 750 kcal/kg-cli, and the average reduction indicator Q2 of the rare earth energy-saving agent is 40-80 kcal-cli. Substitute the data into the formula W %=(Q1−Q0)/Q2×1.5+0.05, and calculate the range of W to be 1.0-1.9.
Step S3: Measure in real-time the content of A mineral and B mineral in the clinker with added rare earth energy-saving admixture, and the thermal energy consumption, and plot the measurement data into a curve to form a data image model, as shown in FIG. 2.
Step S4: Based on the range of the additive amount W obtained in S2, select several data points of additive amount and bring them into the data image model to analyze the thermal consumption of specific additive amounts.
Specifically, select five data points of 1.0, 1.1, 1.2, 1.3, and 1.4 for model comparison and analysis:
When the additive amount is 1.0%, the content of A mineral is 63%, the content of B mineral is 28.8%, and the comprehensive thermal consumption is 750 kcal-cli, a reduction of 6.25% from the original thermal consumption of 800 kcal/kg-cli.
When the additive amount is 1.1%, the content of A mineral is 65%, the content of B mineral is 27.5%, and the comprehensive thermal consumption is 740 kcal-cli, a reduction of 7.5% from the original thermal consumption of 800 kcal/kg-cli.
When the additive amount is 1.2%, the content of A mineral is 67.5%, the content of B mineral is 26%, and the comprehensive thermal consumption is 730 kcal-cli, a reduction of 8.75% from the original thermal consumption of 800 kcal/kg-cli.
When the additive amount is 1.3%, the content of A mineral is 67%, the content of B mineral is 26.5%, and the comprehensive thermal consumption is 725 kcal-cli, a reduction of 9.4% from the original thermal consumption of 800 kcal/kg-cli.
When the additive amount is 1.4%, the content of A mineral is 66%, the content of B mineral is 27.5%, and the comprehensive thermal consumption is 715 kcal-cli, a reduction of 10.6% from the original thermal consumption of 800 kcal/kg-cli.
When the additive amount is 1.0%, the clinker thermal consumption is reduced to the ideal value, and the thermal consumption of the remaining four sets of data is all below the ideal clinker thermal consumption, and all five sets of data meet the basic selection conditions.
Step S5: Select the clinker with different amounts of rare earth energy-saving admixture from S4 for strength testing, and the strength results are shown in Table 2.

TABLE 2
Clinker Strength of Implementation Example 2

| | | | | | | |
|---|---|---|---|---|---|---|
| Additive Amount /% | 1.0 | 1.1 | 1.2 | 1.3 | 1.4 | 0 |
| Strength /MPa | 56 | 54.8 | 54.2 | 54 | 53 | 54 |

Based on the data in Table 2, it can be known that under the condition of 1.0% addition of the rare earth energy-saving admixture, the clinker strength is increased by 2 MPa.
Step S6: The basic selection condition is to reduce the thermal consumption to below the ideal clinker thermal consumption, and the value of strength improvement is the preferred condition, determining the addition amount of the rare earth energy-saving admixture to be 1.0%. The clinker with the determined addition amount is tested for nitrogen oxide content and desulfurization effect.
Under the condition of 1% addition, the clinker thermal consumption is reduced from 800 kcal/kg to 750 kcal/kg; the clinker strength is increased from 54 MPa to 56 MPa; the nitrogen oxide emissions are reduced from 130 mg/m3 to within 50 mg/m3, and sulfur trioxide is stabilized within 30 mg/m3, with significant effects.

Finally, it should be noted that the above examples are only preferred implementations of the present invention. Of course, technicians in this field can make modifications and variations to the invention. If these modifications and variations fall within the scope of the claims and equivalent technology of the present invention, they should be considered as within the protective scope of the present invention.

What is claimed is:

1. A rare earth energy-saving admixture for cement kilns, characterized in that, calculated by mass fraction, it includes 4-22% rare earth composite oxides, 31-49% urea, and 30-49% gypsum.

2. The rare earth energy-saving admixture as claimed in claim 1, is characterized in that the rare earth composite oxides are composed of La2O3 and Y2O3, with La2O3 having a mass content of 98-99%.

3. A preparation method for the rare earth energy-saving admixture for cement kilns as claimed in claim 1, characterized by the following steps:
Step S1: Conduct a thermodynamic diagnostic survey on the original sintering process and material ratio;
Choose a period of stable process operation to conduct thermodynamic calibration of the preheater, high-temperature fan, rotary kiln, calciner, and cooler, and obtain the actual thermal consumption Q1 of the existing clinker based on the measured values;
Step S2: Based on the thermodynamic diagnostic survey, with the ideal clinker index thermal consumption Q0 as the target, calculate the required amount of rare earth energy-saving admixture to be added W in reverse according to the current situation analysis results:
$$\text{\textbackslash [} W \backslash \% = ∖ frac \{ ( Q 1 - Q 0 ) \} \{ Q 2 \} \backslash times 1.5 + 0.05 ∖ ]$$
Where Q0 is the ideal clinker thermal consumption, Q1 is the actual thermal consumption of the existing clinker, and Q2 is the average reduction indicator of the rare earth energy-saving admixture;
Step S3: Measure the changes in the content of C3S and C2S in the cement clinker and the thermal energy consumption under different amounts of rare earth energy-saving admixture added, and draw the measurement data into a curve to establish an image data model;
Step S4: Within the range of W data obtained in S2, select different amounts of data and bring them into the image data model of S3 to compare and analyze the comprehensive thermal consumption of each addition point;
Step S5: Use different amounts of rare earth energy-saving admixture selected in S4 to mix with the existing raw material to obtain mixed raw material, and after high-temperature firing at 1450° C. to obtain clinker, perform strength testing on the clinker;
Step S6: Based on the results of S4 and S5, determine the amount of rare earth energy-saving admixture to be added with the basic selection condition of reducing the thermal consumption to below the ideal clinker thermal consumption, and the value of strength improvement as the preferred condition.

4. The preparation method for the rare earth energy-saving admixture for cement kilns as claimed in claim 1, characterized in that the average reduction indicator Q2 of the rare earth energy-saving admixture is (5% to 10%) of Q1.

5. The preparation method for the rare earth energy-saving admixture for cement kilns as claimed in claim 1, characterized in that in step S5, the rare earth energy-saving admixture is ground to a particle size of less than 0.5 mm before being mixed with the raw material.
